(19) United States
(12) Patent Application Publication
(10) Pub. No.: US 2024/0050938 A1
(43) Pub. Date: Feb. 15, 2024

(54) APPARATUS FOR TESTING A LIQUID SPECIMEN USING SUCTION

(71) Applicant: CLINICAL DESIGN TECHNOLOGIES LIMITED, Devon (GB)

(72) Inventor: Oliver BLACKWELL, Devon (GB)

(21) Appl. No.: 18/268,191

(22) PCT Filed: Dec. 10, 2021
(86) PCT No.: PCT/GB2021/000138

§ 371 Date: Jun. 16, 2023

(30) Foreign Application Priority Data
Dec. 17, 2020 (GB) 219998.0

(51) Int. Cl. B01L 3/00

(52) U.S. Cl. CPC B01L 3/502; B01L 2400/049; B01L 2200/0689; B01L 2400/0478; B01L 2300/123; B01L 2300/0672; B01L 2200/026

(57) ABSTRACT

Apparatus (2) for testing a liquid specimen (4), which apparatus (2) comprises: (i) a collection container (6) for collecting the liquid 2 specimen (4); (») a test container (8) for testing the liquid specimen (4); (Hi) response portions (10) which are in the test container (8) and which are for responding to contact with the liquid specimen (4) to give at least one test result; and (iv) transfer means (12) which enables the collection container (6) to be connected to the test container (8) for transferring the liquid specimen (4) from the collection container (6) to the test container (8) such that the liquid specimen (4) is able to contact the response portions (10) in the test container (8) and enable the response portions (10) to react to the liquid specimen (4) for the testing and characterised in that: (V) the apparatus (2) is such that liquid specimen (4) is transferred from the collection container (6) to the test container (8) by suction; and (vi) the apparatus (2) is such that the liquid specimen (4) that is transferred to the test container (8) remains in the test container (8).

This invention relates to apparatus for testing a liquid specimen and, more especially, this invention relates to apparatus for testing a liquid specimen using suction.

A liquid specimen from a patient is often tested to diagnose or monitor one or more medical conditions of the patient. Typically the liquid specimen is handled and this presents clinical infection risks. Also, the liquid specimen may be unpleasant to handle, for example if the liquid specimen is urine.

It is an aim of the present invention to avoid or reduce the above mentioned problems.

Accordingly, in one non-limiting embodiment of the present invention there is provided apparatus for testing a liquid specimen, which apparatus comprises:
(i) a collection container for collecting the liquid specimen;
(ii) a test container for testing the liquid specimen;
(iii) response portions which are in the test container and which are for responding to contact with the liquid specimen to give at least one test result; and
(iv) transfer means which enables the collection container to be connected to the test container for transferring at least some of the liquid specimen from the collection container to the test container such that the transferred liquid specimen is able to contact the response portions in the test container and enable the response portions to react to the liquid specimen for the testing, and characterised in that:
(v) the apparatus is such that the liquid specimen is transferred from the collection container to the test container by suction; and
(vi) the apparatus is such that the liquid specimen that is transferred to the test container remains in the test container.

The apparatus of the present invention is advantageous in that the liquid specimen, for example urine, is able to be tested without the need for undue exposure to the liquid specimen and the resultant clinical infection risks. Furthermore, where the liquid specimen is unpleasant, for example in the case of urine, the apparatus of the present invention enables the liquid specimen to be tested and subsequently disposed of as pleasantly as possible.

The apparatus may be one in which the transfer means enables the collection container to be separated from the test container, whereby the liquid specimen that has been transferred to the test container is able to be tested without the collection container being present. If desired however the collection container and the test container may stay together during the testing of the liquid specimen.

The apparatus may be one in which the test container is sealable after the collection container has been separated from the test container. This helps to avoid liquid specimen getting on the outside of the test container and thereby being unpleasant for a person operating the apparatus and/or causing an infection risk for the person operating the apparatus.

The apparatus of the present invention may be one in which the suction is a suction which is provided by a syringe. In this case, the suction may typically be provided at the time of use of the apparatus.

Alternatively, the apparatus of the present invention may be one in which the suction is a suction which is formed in the test container during manufacture of the apparatus. In this case, the suction may typically be provided at the time of manufacture of the test container, for example by forming the test container with a sealed vacuum

When the suction is a suction which is sealed in the test container, then the apparatus may be one in which the transfer means is operable to enable access to the suction in the test container, and in which the transfer means comprises an opener means and a sealable diaphragm which is for receiving the opener means. The sealable diaphragm is preferably made of a rubber material. Other materials may be employed. Various types of opener means may be employed.

The apparatus may comprise a needle and a conduit for dipping into the liquid specimen. The liquid specimen may be in the collection container. Alternatively the liquid specimen may be in a bed pan.

The transfer means may be through a lid for the collection container. Alternatively, the transfer means may be a conduit for connecting the test container to the liquid specimen. The liquid specimen may be in a bed pan or other container. Where the transfer means is integral with a lid, it may be advantageous for the conduit to reach to the bottom or close to the bottom of the collection container in order to obtain small volume samples.

In all embodiments of the invention, the apparatus may be one in which the transfer means comprises a first part and a second part, and in which the first part and the second part are connectable together to form a sealed connection. The first part and the second part may be separable from each other to enable the test container to be separated from the collection container after the test container has been provided with the liquid specimen from the collection container. The first and the second parts may be connected together by a push fit. Other types of connection means for connecting together the first and the second parts may be employed so that, for example, the first and the second parts may be connected together by a screw fit.

The apparatus may be one in which the collection container comprises a lid and a body portion, and in which the lid is a removable lid which is a screw fit on the body portion. Other types of collection container may be employed.

The response portions may be in a line. Alternatively, the response portions may be such that they define other shapes, for example a circle.

Embodiments of the invention will now be described solely by way of example and with reference to the accompanying drawings in which:

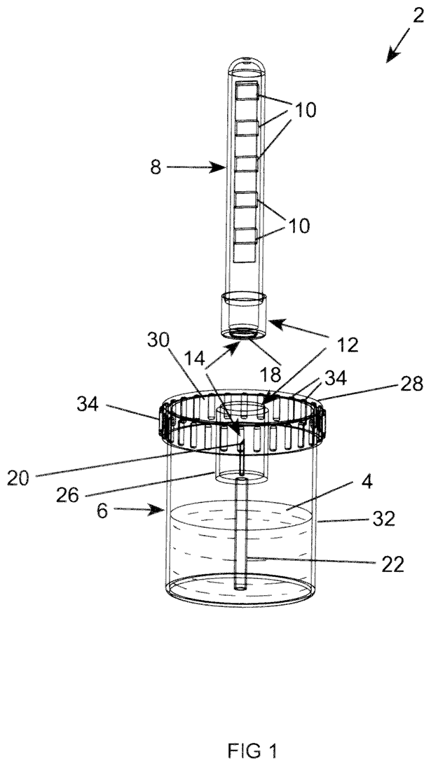

FIG. 1 shows first apparatus of the present invention with parts being separated;

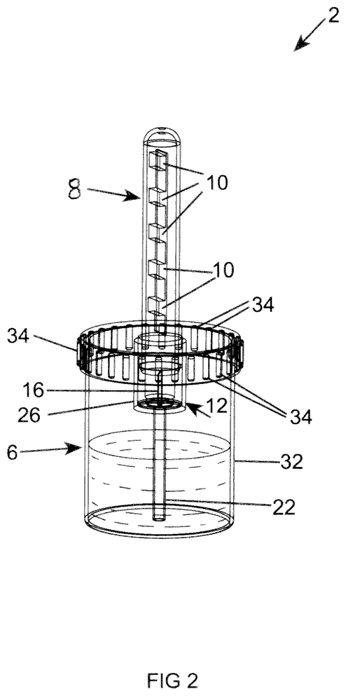

FIG. 2 shows the apparatus of FIG. 1 with the parts being connected together;

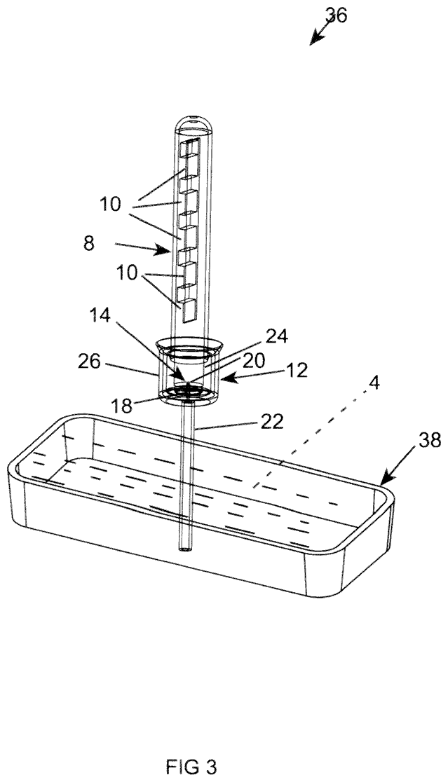

FIG. 3 shows second apparatus of the present invention;

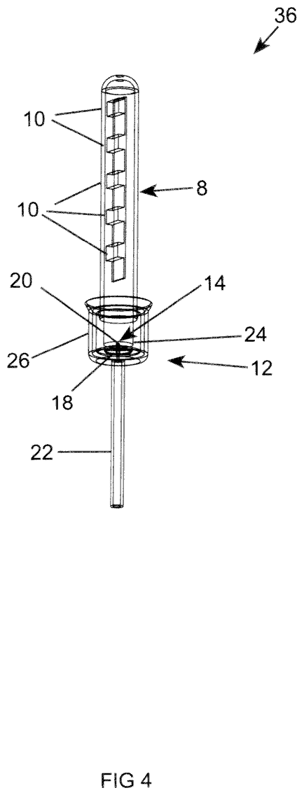

FIG. 4 shows part of the apparatus shown in FIG. 3;

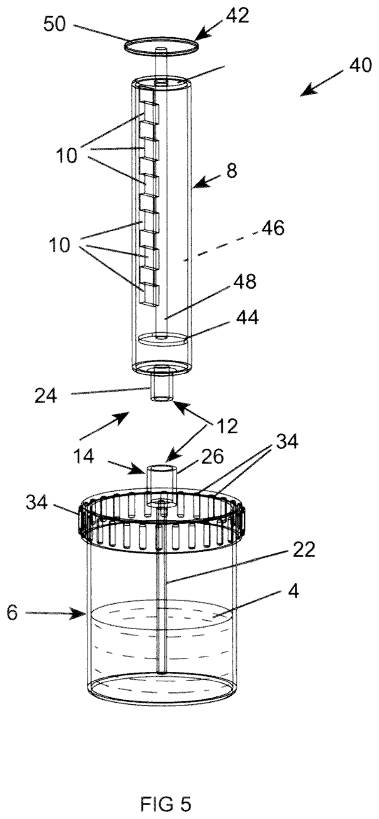

FIG. 5 shows third apparatus of the present invention and in a separated condition;

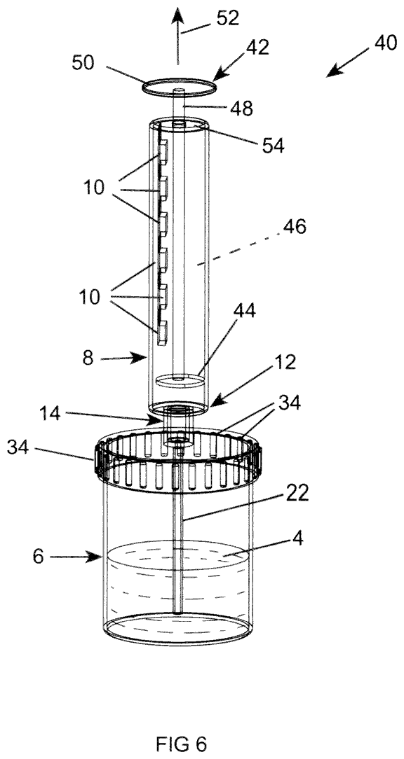

FIG. 6 shows the apparatus of FIG. 5 in a connected condition;

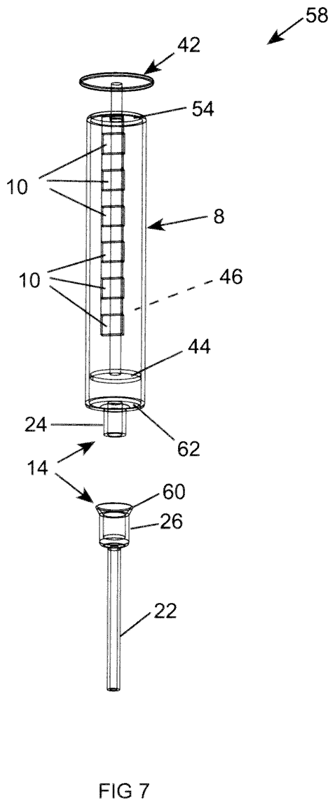

FIG. 7 shows parts of the apparatus shown in FIGS. 5 and 6 and in a separated condition; and

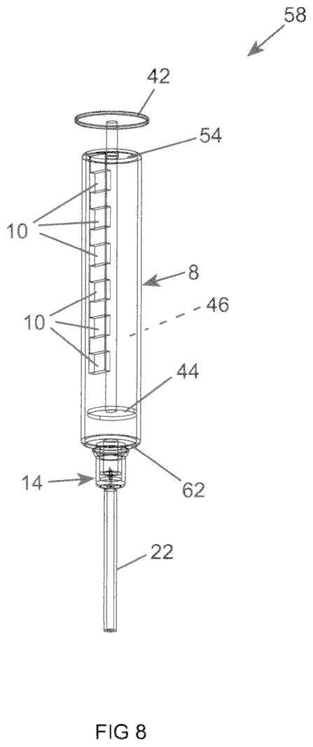

FIG. 8 shows the parts of the apparatus shown in FIG. 7 but connected together.

Referring to FIGS. 1 and 2, there is shown first apparatus 2 for testing a liquid specimen 4. The apparatus 2 comprises a collection container 6 for collecting the liquid specimen 4, and a test container 8 for testing the liquid specimen 4. Response portions 10 are in the test container 8. The response portions 10 are for responding to contact with the liquid specimen 4 to give at least one test result.

The apparatus 2 comprises transfer means 12 which enables the collection container 6 to be connected to the test container 8 for transferring at least some of the liquid specimen 4 from the collection container 6 to the test container 8 such that the transferred liquid specimen 4 is able to contact the response portions 10 in the test container 8 and enable the response portions 10 to react to the liquid specimen 4 for the testing.

The apparatus 2 is such that the liquid specimen 4 is transferred from the collection container 6 to the test container 8 by suction.

The apparatus 2 is also such that the liquid specimen 4 that is transferred to the test container 8 remains in the test container 8.

The transfer means 12 allows the collection container 6 to be separated from the test container 8, whereby the liquid specimen 4 that has been transferred to the test container 8 is able to be tested without the collection container 6 being present. Alternatively, the liquid specimen 4 may be tested in the test container 8 while the test container 8 remains connected to the collection container 6.

In the apparatus 2, the suction is a suction which is sealed in the test container 8 at the time of manufacture of the test container 8.

The transfer means 12 is operable to enable access to the suction in the test container 8. More specifically, the transfer means 12 comprises a sealable arrangement 14. The sealable arrangement 14 comprises opener means 16 and a sealable diaphragm 18. The sealable diaphragm 18 is for receiving the opener means 16. The sealable diaphragm 18 is made of a rubber material. The opener means 16 is in the form of a hollow needle with a pointed end 20 which penetrates the sealable diaphragm 18 when the test container 8 is connected to the collection chamber 6. The apparatus 2 is thus one in which the test container 8 is sealable after the collection container 6 has been separated from the test container 8. This helps to avoid liquid specimen 4 getting on the outside of the test container 8 and thereby being unpleasant for a person operating the apparatus 2 and/or causing an infection risk for the person operating the apparatus 2.

The opener means 16 includes a conduit 22. The conduit 22 is for dipping into the liquid specimen 4 in the collection container 6.

FIG. 1 shows the test container 8 separate from the collection container 6, but in a position ready for connection to the collection container 6. FIG. 2 shows the test container 8 connected to the collection container 6. The connection is enabled by the transfer means 12. More specifically, the transfer means comprises a first part 24 on the test container 8, and a second part 26 on the collection container 6. The first part 24 and the second part 26 are connectable together to form a sealed connection as shown in FIG. 2. The first part 24 and the second part 26 are separable from each other to enable the test container 8 to be separated from the collection container 6 after the test container 8 has been provided with the liquid specimen 4 from the collection container 6.

The first part 24 is a short tubular portion which contains the sealable diaphragm 18. The second part 26 is in the form of a recessed portion which depends from a lid 28 forming part of the collection container 6. The first part 24 thus forms a male connecting part, whilst the second part 26 forms a female connecting part.

In use of the apparatus 2, when the first part 24 is pushed into the second part 26, the pointed end 20 of the opener means 16 pushes through the sealable diaphragm 18. The suction in the test container 8 then causes a required amount of the liquid specimen 4 to be sucked into the test container 8. The volume of the liquid specimen 4 sucked into the test container 8 can be controlled as required by controlling the vacuum. The control of the amount of liquid specimen 4 sucked into the container 8 enables the response portions 10 to be soaked to the required level and not oversoaked or undersoaked. The optimum soaking of the response portions 10 can alternatively be achieved by a point of care suction.

For testing of the liquid specimen 4, the liquid specimen 4 that is transferred from the collection container 6 to the test container 8 remains in the test container 8. The transfer means 12 is such that the collection container 6 is able to be separated from the test container 8 simply by pulling the test container 8 away from the collection container 6 so that the first part 24 is pulled out of the second part 26. When this happens, the opener means 16 is removed from the sealable diaphragm 18. The sealable diaphragm 18 is made of a rubber material which automatically seals itself. Thus the liquid specimen 4 in the test container 8 is sealed in the test container 8 and is able to be tested without the collection container 6 being present. The remaining liquid specimen 4 in the collection container 6 stays in the collection container 6. This liquid specimen 4 in the collection container 6 cannot escape from the collection container 6 because the second part 26 is integrally formed with a flat part 30 of the lid 28. The collection container 6 comprises the lid 28 and a body portion 32. When the lid 28 is on the body portion 32, the liquid specimen 4 is able to leave the collection container 6 and enter the test container 8 is via the opener means 16 in the form of the hollow needle and this happens when the first part 24 is in the second part 26 and the opener means 16 has penetrated the sealable diaphragm 18. The liquid specimen 4 that has not been used and that is in the collection container 6 can be disposed of as may be required. Alternatively, if the test conducted in the test container 8 indicates further testing of the liquid specimen 4, then the liquid specimen 4 that is remaining in the collection container 6 can be further tested. If necessary, this liquid specimen in the collection container 6 can be tested by sending the collection container 6 away for further testing at a separate testing station.

The lid 28 is a screw fit on the body portion 32. With the lid 28 removed from the body portion 32, the collection container 6 can be filled with the urine 4 prior to connecting the test container 8 to the collection container 6, as can be appreciated from FIG. 1. After the required amount of liquid specimen 4 has been introduced into the test container 8 by connecting together the test container 8 and the collection container 6 as shown in FIG. 2, the test container 8 can then be removed from the collection container 8. Alternatively, the test container 8 may remain connected to the collection container 6. The collection container 6 and the test container 8 will have the position shown in FIG. 1, but there will then be liquid specimen 4 in the test container 8. When this has happened, if the unused liquid specimen 4 in the collection container 6 is not required, then it can be disposed of in the collection container 6, or it can be disposed of by removing the lid 28 from the body portion 32 and pouring the liquid specimen 4 into a waste disposal system. The lid 28 can then screwed back on the body portion 32 for enabling the safe disposal of the collection container 6 without the liquid specimen 4. The lid 28 is provided with externally projecting ribs 34 which form hand-grip means for facilitating gripping of the lid 28 and screwing and unscrewing the lid 28 on the body portion 32.

In the test container 8, the response portions 10 are in a line. FIG. 1 shows the response portion 10 from the front. FIG. 2 shows the response portions 10 from the front and one side. As can best be appreciated from FIG. 2, the response portions 10 are in the form of pads. The response portions 10 may be of any required shape. The response portions 10 are designed to react with and give a result to the liquid specimen 4 that is being tested. The liquid specimen 4 shown in FIGS. 1 and 2 is urine. The liquid specimen 4 may however be another type of bodily fluid, for example blood.

Referring now to FIGS. 3 and 4, there is shown second apparatus 36 for testing a liquid specimen 4. Similar parts as in the apparatus 2 have been given the same reference numerals for ease of comparison and understanding.

The apparatus 36 comprises a collection container 38 which is an open collection container 38. This is in contrast to the collection container 6 in the apparatus 2 which is a closed collection container 6. The remaining parts of the apparatus 36 can be substantially the same as in the apparatus 2 as shown. In use of the apparatus 36, when the test container 8 is indirectly connected to the collection container 38, the suction in the test container 8 sucks up the liquid specimen 4 from the collection container 38, through the conduit 22 and into the test container 8. Thereafter, the test container 8 is separated from the collection container 38 by simply raising the test container 8 connected to the conduit 22 from the liquid specimen 4 in the collection container 38 as can be appreciated from a comparison of FIGS. 3 and 4. The conduit 22 can then be disconnected from the test container 8. The conduit 22 and the second part 26 are preferably formed as a single item made up of separate parts.

In FIG. 3, the response portions 10 are shown from the side and the rear. In FIG. 4, the response portions 10 are shown in the same position. The collection container 38 may be a bedpan which may be a convenient way to collect the liquid specimen 4 from a patient who is confined to bed, for example in hospital. If appropriate, the liquid specimen 4 could be collected in the collection container 38 and then transferred to the collection container 6.

FIGS. 5 and 6 show third apparatus 40 which is like the apparatus 2. The apparatus 40 has suction-providing means 42 for providing a suction at the time of use of the apparatus 40. The suction-providing means 42 operates like a syringe. More specifically, the suction-providing means 42 comprises a disc 44 which operates as a tight sliding fit in a bore 46 in the test container 8. The disc 44 is connected by a connecting rod 48 to a hand grip 50. If the hand grip 50 is pulled upwardly as shown by the arrow 52 in FIG. 6, then a suction is formed in the test container 8. In use, the hand grip 50 is not pulled upwardly until the test container 8 is moved from the non-connected position shown in FIG. 5 to the connection position shown in FIG. 6. In the connected position shown in FIG. 6, the transfer means 12 will be ready for operation. Thus, when the hand grip 50 is pulled upwardly in the direction of the arrow 52, the disc 44 sucks the liquid specimen 4 upwardly through the conduit 22 and into the test container 8.

In the apparatus 40, the first part 24 fits into the second part 26 such that there is no pointed end 20. There is thus no puncturing of a sealable diaphragm 18. In the apparatus 40, the transfer means 12 forms a sealing arrangement 14 in order to enable the suction to be formed, but there is no puncturing required.

Referring now to FIGS. 7 and 8, there is shown fourth apparatus 58. The apparatus 58 has the suction-providing means 42 of the apparatus 36. The apparatus 58 does not have the collection container 6 of the apparatus 2. Instead, the apparatus 58 is such that the conduit 22 is for use with a collection container 6 as shown in the apparatus 36 of FIG. 3.

It is to be appreciated that the embodiments of the invention described above with reference to the accompanying drawings have been given by way of example only and that modifications may be effected. Thus, for example, the collection containers 6, the test containers 8 and the response portions 10 may be of different shape to those shown. Other types of transfer means 12 may be employed. The liquid specimen 4 may be of any suitable required liquid specimen. Individual components shown in the drawings are not limited to use in their drawings and they may be used in other drawings and in all aspects of the invention. The invention also extends to the individual components mentioned and/or shown above, taken singly or in any combination.

1-12. (canceled)

13. Apparatus for testing a liquid specimen, which apparatus comprises:
(i) a collection container for collecting the liquid specimen;
(ii) a test container for testing the liquid specimen;
(iii) response portions which are in the test container and which are for responding to contact with the liquid specimen to give at least one test result; and
(iv) transfer means which enables the collection container to be connected to the test container for transferring at least some of the liquid specimen from the collection container to the test container such that the transferred liquid specimen is able to contact the response portions in the test container and enable the response portions to react to the liquid specimen for the testing,
and characterised in that:
(v) the apparatus is such that the liquid specimen is transferred from the collection container to the test container by suction; and
(vi) the apparatus is such that the liquid specimen that is transferred to the test container remains in the test container.

14. Apparatus according to claim 13 in which the transfer means enables the collection container to be separated from the test container, whereby the liquid specimen that has been transferred to the test container is able to be tested without the collection container being present.

15. Apparatus according to claim 13, in which the liquid specimen can be tested in the test container while the test container remains connected to the collection container.

16. Apparatus according to claim 13, in which the test container is sealable after the collection chamber has been separated from the test container.

17. Apparatus according to claim 13, in which the suction is a suction which is provided by a syringe.

18. Apparatus according to claim 17, in which a disc which operates as a tight sliding fit in a bore in the test container, in which the disc is connected by a connecting rod to a hand grip, and in which if the hand grip is pulled upwardly then a suction is formed in the test container.

19. Apparatus according to claim 13, in which the suction is a suction which is formed in the test container during manufacture of the apparatus.

20. Apparatus according to claim 13, in which the transfer means is operable to enable access to the suction in the test container, and in which the transfer means comprises an opener means and a sealable diaphragm which is for receiving the opener means.

21. Apparatus according to claim 20, in which the sealable diaphragm is made of a rubber material.

22. Apparatus as claimed in claim 20, in which the opener means is in the form of a hollow needle with a pointed end which can penetrate the sealable diaphragm when the test container is connected to the collection chamber.

23. Apparatus according to claim 13, in which the transfer means comprises a conduit for dipping into the liquid specimen.

24. Apparatus according to claim 13, in which the transfer means comprises a first part and a second part, in which the first part and the second part are connectable together to form a sealed connection, and in which the first part and the second part are separable from each other to enable the test container to be separated from the collection container after the test container has been provided with the liquid specimen from the collection container.

25. Apparatus according to claim 24, in which the first part is a short tubular portion which contains a sealable diaphragm and in which the second part is in the form of a recessed portion which depends from a lid forming part of the collection container.

26. Apparatus according to claim 25, in which the second part is integrally formed with a flat part of the lid, whereby liquid specimen remaining in the collection container cannot escape from the collection container.

27. Apparatus according to claim 24, in which the first and second parts are connected together by a push fit.

28. Apparatus according to claim 13, in which the collection container comprises a lid and a body portion, and in which the lid is a removable lid which is a screw fit on the body portion.

29. Apparatus according to claim 28, in which when the lid is on the body portion, the liquid specimen is able to leave the collection container and enter the test container via the opener means.

30. Apparatus according to claim 13, in which a plurality of response portions are arranged in a line.

31. Apparatus according to claim 13, in which the collection container which is an open collection container.

32. Apparatus according to claim 13, in which the collection container is a closed collection container.
